(19) United States
(12) Patent Application Publication
(10) Pub. No.: US 2017/0092277 A1
(43) Pub. Date: Mar. 30, 2017

(54) Search and Access System for Media Content Files

(71) Applicant: Seagate Technology LLC, Cupertino, CA (US)

(72) Inventor: Thomas Sandison, Loveland, CO (US)

(73) Assignee: Seagate Technology LLC

(21) Appl. No.: 14/871,193

(22) Filed: Sep. 30, 2015

(51) Int. Cl. G10L 17/14; G10L 15/30; G10L 17/00; G10L 15/26; H04L 29/08; G10L 19/018

(52) U.S. Cl. CPC G10L 17/14; H04L 67/10; G10L 19/018; G10L 17/005; G10L 15/265; G10L 15/30

(57) ABSTRACT

Method and apparatus for managing media content files. In some embodiments, a processing circuit is used to identify a reference audio sequence (e.g., spoken words) in an audio portion of a media content file. A data structure stored in a memory links each portion of the reference audio sequence with an associated time stamp that identifies a time location of the associated portion of the reference audio sequence within the media content file with respect to a reference point of the media content file. The data structure is searched using an input search string to identify a selected portion of the reference audio sequence in the media content file. Playback of the media content file is initiated on a display device beginning at an intermediate point of the media content file corresponding to the time stamp associated with the selected portion of the reference audio sequence.

### SUMMARY

Various embodiments of the present disclosure are generally directed to a method and apparatus for managing media content files.

In some embodiments, a processing circuit is used to identify a reference audio sequence in an audio portion of a media content file. A data structure stored in a memory links each portion of the reference audio sequence with an associated time stamp that identifies a time location of the associated portion of the reference audio sequence within the media content file with respect to a reference point of the media content file. The data structure is searched using an input search string to identify a selected portion of the reference audio sequence in the media content file. Playback of the media content file is initiated on a display device beginning at an intermediate point of the media content file corresponding to the time stamp associated with the selected portion of the reference audio sequence.

In other embodiments, an apparatus has a processing circuit and a retrieval circuit. The processing circuit is configured to identify a sequence of spoken words in an audio portion of a rich media content (RMC) file stored in a first memory. The processing circuit is further configured to generate, and store in a second memory, a data structure that links each of the spoken words with an associated time stamp that identifies a time location of the spoken word within the RMC file with respect to a beginning of the RMC file. The retrieval circuit is configured to search the data structure using an input search string to identify a selected spoken word in the RMC file. The retrieval circuit is further configured to initiate playback of the RMC file on a display device beginning at an intermediate point of the RMC file responsive to the time stamp associated with the selected spoken word.

In further embodiments, an apparatus has a first programmable processor with associated programming in a memory location which, when executed, uses phoneme recognition to identify a sequence of spoken words in each of a plurality of rich media content (RMC) files stored in a memory, generates a data structure that links each of the spoken words with an associated time stamp that identifies a time location of the spoken word within the associated RMC file and an associated human speaker which spoke the associated spoken word, and stores the data structure in a memory. A second programmable processor has associated programming in a memory location which, when executed, searches the data structure using an input search string to identify a selected spoken word in the RMC file, and initiates playback of the RMC file on a display device beginning at an intermediate point of the RMC file responsive to the time stamp associated with the selected spoken word.

### BRIEF DESCRIPTION OF DRAWINGS

FIG. 1 is a functional block diagram of a data storage device and a host device in accordance with some embodiments.

FIG. 2 is a functional block diagram of multiple storage devices such as exemplified in FIG. 1 in a network environment.

FIG. 3 is a functional block representation of processing applied to a rich media content (RMC) file stored in a data storage device of FIGS. 1-2 in accordance with some embodiments.

FIG. 4 illustrates an exemplary format of aspects of the RMC file of FIG. 3.

FIG. 5 shows a processing circuit configured to generate voice characteristics dynamic library (VCDL) data structure in accordance with some embodiments.

FIG. 6 shows a retrieval circuit configured to search, retrieve and playback a selected RMC file in accordance with some embodiments.

FIG. 7 is a table structure showing various exemplary forms of search inputs.

FIG. 8 depicts different output match sets from a given VCDL data structure using different exemplary search inputs.

FIG. 9 is a user interface that can be used to request and display various match sets such as generated in FIG. 8.

FIG. 10 is a flow chart for a file management routine carried out in accordance with some embodiments.

### DETAILED DESCRIPTION

The present disclosure is generally directed to file management systems, and more particularly to searching and accessing rich media content (RMC) files stored in a data storage device.

Rich media content (RMC) files (also referred to as “media content files”) are data sets having audio and/or video data components. RMC files can take a variety of forms, such as professional or amateur audio and video recordings. Examples of RMC files can include full length movies, advertisements, episodes, marketing and instructional videos, and video games. Other examples can include recordings of meetings, teleconferences, public events, parties, home movies, and the like. With the advent of smart phones, tablets, web cams and other portable devices with audio and visual recording capabilities, RMC files are being generated and stored in home, network and cloud based storage applications at an ever increasing rate.

A limitation associated with current generation RMC file management systems is the inability to efficiently search and access such files based on content. It may be desirable, for example, to locate a portion of an RMC file in which a particular phrase was spoken, such as a particular topic that was discussed at some point over the course of a multi-day business meeting. In another case, it may become desirable to locate the telling of a particular story by a family member somewhere within a large collection of home movies.

Current generation RMC file management systems often allow some measure of classification of the style and content of RMC files. However, once a given RMC file having desired content is located, such systems usually require a manual searching operation to locate a particular point in the file where the desired content appears.

Accordingly, various embodiments of the present disclosure are generally directed to a system that provides efficient search and access functions for rich media content (RMC) files. The system generates a voice characteristics dynamic library (VCDL) data structure that allows a user to locate particular words that were spoken or otherwise presented within the content of the files, and initiates playback of the RMC file at that location.

To provide a general overview, any video or audio recording can be run through the process to create a database that includes various objects. Each object (entry) may include the spoken word, the voice (speaker identification, ID) who spoke the word, a timestamp value such as the number of seconds from the beginning of the recording (or other time metric), and a reference to the recorded file (e.g., file type such as AVI, MP3, the file name, etc.).

Digital signal processing (DSP) technology can be used to determine to whom a given voice belongs. If there is not an existing entry in the database that matches a currently detected voice, a new entry can be created. The database may be built on the supper set of all objects for all evaluated files. A search application interface can be used to allow a user to enter search strings. Short searches, such as “the,” would tend to produce many hits. The interface may allow the user to provide greater specificity to the search by adding additional words and narrowing the search results.

A playback application can be used to generate a list of matches based on a search of the data base. The end user can select the associated recording, and the application can be configured to begin playback at the number of seconds associated with the object, minus a small interval to enable playback of the entire quote or phrase spoken by the speaker. Multiple users could contribute to a common VCDL data base so that all could add entries and gain access to audio results quickly.

As explained in greater detail below, in some embodiments the VCDL data structure is generated by processing a set of content files using phoneme recognition algorithms. The phonemes are used to identify audible words within the content files, and the words are characterized and stored in the VCDL data structure.

The VCDL data structure may be sorted to arrange the spoken words by source (e.g., individual speakers, etc.). This may include subjecting the detected phonemes to a digital signal processing (DSP) block to compare the phonemes with known phonemes from a set of individuals or other sources. In some cases, the identity of a given source may not be known and so is assigned a new speaker designation. This can later be tagged by the user as a particular individual. Over time, the phonemes can be used as an input to the DSP block database for future speaker recognition.

The data structure may further include time stamps of the occurrences of each of the phonemes. In this way, a user can, through a suitable interface, input a word or phrase that was spoken. The system can search the data structure and locate that portion of the content, which will be queued up and played. Options for the interface include identifying the particular speaker, giving a range of time within the content when the spoken word or phrase occurs, the presence of other media sources (e.g., power point presentations), etc.

In some cases, the VCDL library is constructed using many RMC files to provide a personalized search system for a given library. Search inputs can include search terms (spoken words or phrases desired to be located), particular speakers, the approximate timeframe at which the words or phrases were provided (either via date or elapsed time within a given file), the name of the file or files to be searched, etc. The VCDL may be provided as a cloud based service that automatically updates the VCDL structure as new content is provided to a particular user account.

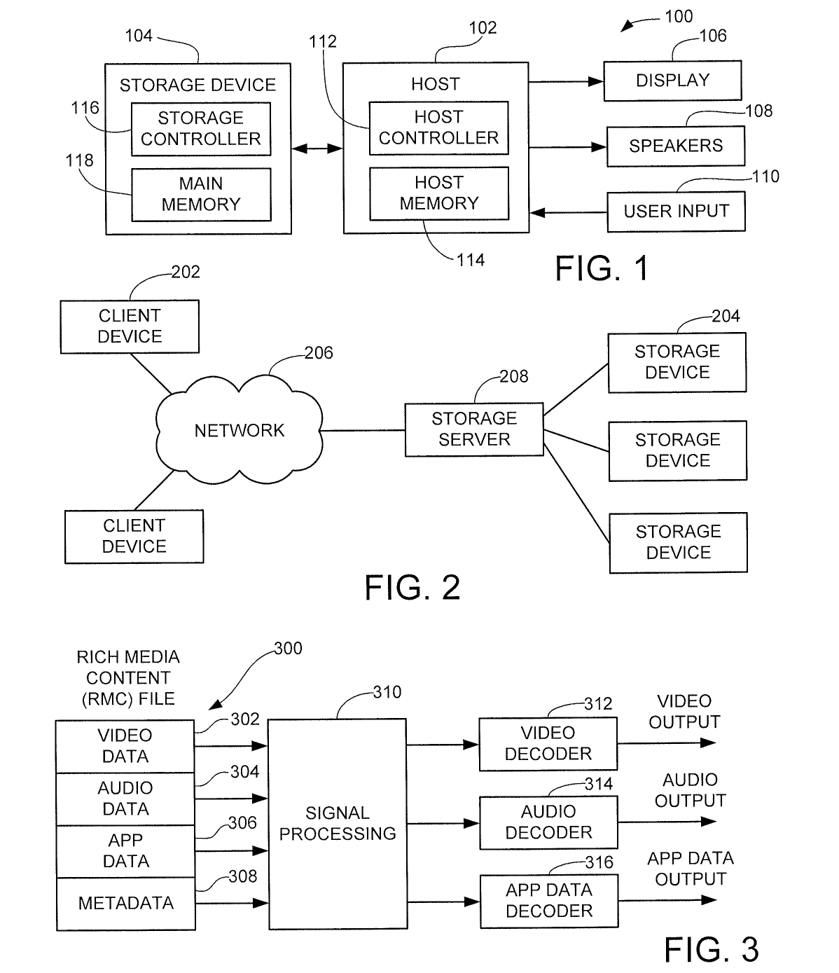

These and other features and aspects of various embodiments of the present disclosure can be understood beginning with a review of FIG. 1 which provides a functional block diagram for a data management system 100 in accordance with some embodiments. The system 100 includes a host device 102, a storage device 104, and various host interface devices including a display 106, speakers 108 and one or more user input devices 110.

The system 100 may take any number of suitable forms, such as but not limited to a personal computer (PC) or workstation, a home entertainment system, a tablet or other handheld portable device, or a distributed processing system. The host device 102 includes a host controller circuit 112 (“controller”) and host memory 114. The host controller circuit 112 may be a hardware circuit and/or a programmable processor that uses suitable programming stored in the memory 114. The storage device 104 includes similar storage controller circuitry 116 and a main memory 118. The main memory 118 may be a rotatable or solid-state memory store used to store user data files from the host device 102.

The display 106 may be a CRT or flat screen monitor, touch screen, etc. configured to display video information to a user in a human visible format. The video information is forwarded from the host device 102. The speakers 108 are configured to output audio information from the host device in a human audible format. The user input block 110 allows a user to input commands to the host device and may incorporate, for example, menu screens or other aspects of the display 106. Other peripheral devices can be used as desired.

In some cases, a rich media content (RMC) file may be stored in the main memory 118. A suitable user command may be provided via the input block 110 to access and output a video component of the file using the display 106 and an audio component of the file using the speakers 108.

FIG. 2 is a functional block representation of another data management system 200 similar to the system 100 of FIG. 1. The system 200 in FIG. 2 is a distributed data system, such as but not limited to a cloud computing environment. Various client (host) devices 202 access data stored on various storage devices 204 via a network 206 and a storage server 208. The client devices 202 may be similar to the host device 102 in FIG. 1, and the storage devices 204 may be similar to the storage device 104 in FIG. 1. The network may take any number of suitable forms including a local area network (LAN), wide area network (WAN), the Internet, etc. The storage server 206 may take a form similar to the host device 102 in FIG. 1 and provides data I/O control functions with regard to the storage devices 204.

As before, a rich media content (RMC) file may be stored on one or more of the storage devices 204. A user input provided through a selected client device 204 results in the transfer and display of respective video and audio components at the client device.

FIG. 3 shows a decoding sequence for an exemplary RMC file 300 in accordance with some embodiments. Other forms of RMC files, and other forms of decoding, may be used. The RMC file 300 shown in FIG. 3 includes video data 302, audio data 304, application (app) data 306 and metadata 308. The format is merely exemplary, as RMC files can take any number of forms, including but not limited to forms with just audio, with just audio and video components, etc.

The video and audio data 302, 304 may be arranged in the form of sequential frames of respective block sizes. The app data 308 may represent computer code, data or other information associated with the RMC file, such as electronic slide show presentation or an executable computer program that is incorporated as part of the multi-media RMC file presentation. The metadata 308 provides control data associated with the video, audio and app content.

A signal processing block 310 receives and processes the various components of the RMC file 300. The video frames are separated and forwarded to a video decoder circuit 312 which generates a video output suitable for use by a display device, such as the display 106 in FIG. 1. The audio frames are separated and forwarded to an audio decoder circuit 314 which generates an audio output suitable for use by an audio output device, such as the speakers shown in FIG. 1. When used, the app data are decoded using an app data decoder circuit 316 which provides the requisite app data output appropriate to the type of app data in the RMC file.

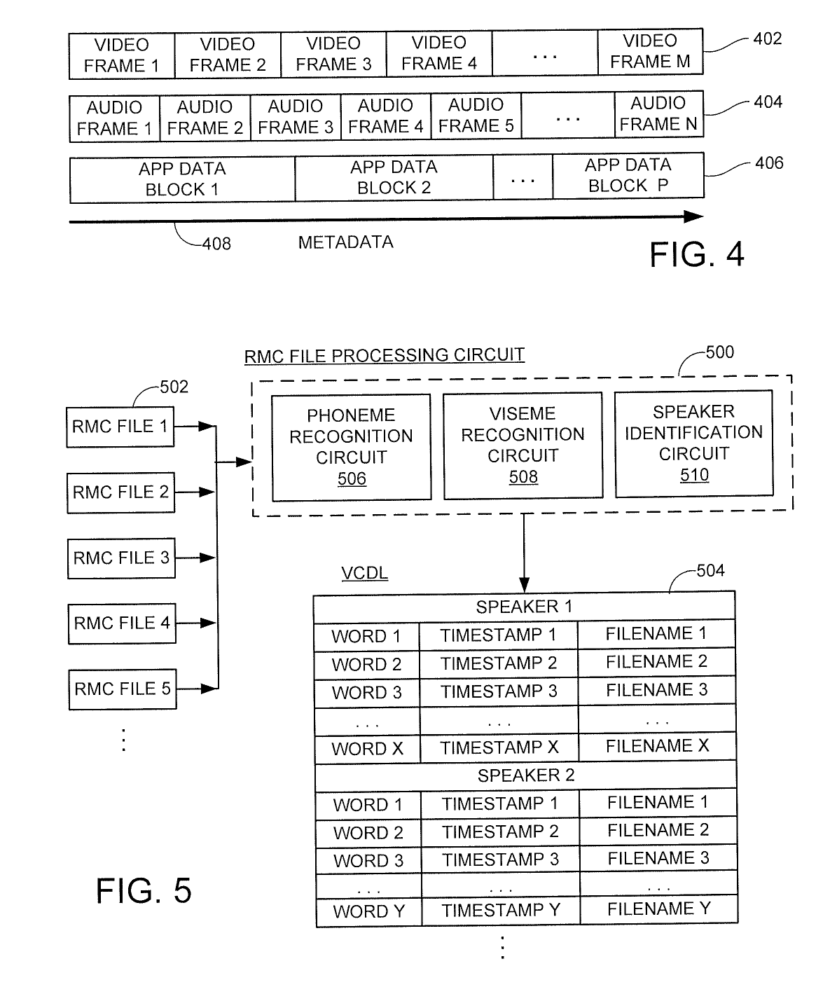

FIG. 4 shows the arrangement of these respective data types into frames. The video data 302 from FIG. 3 are arranged in FIG. 4 as video frames 402 denoted as video frames 1 through M. The audio data 304 are arranged as audio frames 404 denoted as audio frames 1 through N.

In some embodiments, the video frames 402 each represent a single picture of video data to be displayed by the display device at a selected rate, such as 30 video frames/second. The video data may be defined by an array of pixels which in turn may be arranged into blocks and macroblocks. The pixels may each be represented by a multi-bit value, such as in accordance with an RGB model (red-green-blue) or a YUV (luminance and chrominance) model.

The audio frames 404 may represent multi-bit digitized data samples that are played at a selected rate (e.g., 44.1 kHz or some other value). Some standards may provide around 48,000 samples of audio data/second. In some cases, audio samples may be grouped into larger blocks, or groups, that are treated as audio frames. As each video frame generally occupies about 1/30 of a second, an audio frame may be defined as the corresponding approximately 1600 audio samples that are played during the display of that video frame. Other arrangements can be used as required, including treating each audio data block and each video data block as a separate frame.

Many numbers of audio and video frames of data will be played by the respective decoder circuits 312, 314 (FIG. 3) each second. Different rates of frames may be presented. A synchronization (sync) timing scheme will be established to nominally ensure the audio is in sync with the video irrespective of the actual numbers of frames that pass through the respective decoder circuits.

FIG. 4 further shows a number of app blocks 406, from block 1 to block P. The app blocks 406 correspond to the app data 306 from FIG. 3. When incorporated into an RMC file, the app blocks may provide sequenced data as discussed above. The data may or may not be time synchronized with the audio and video frames. The blocks may take any suitable size. Finally, FIG. 4 shows metadata (arrow 408) that provides various header, control, sync, address, error correction and other data that may be used to track the other data components of the file.

FIG. 5 shows an RMC file processing circuit 500 constructed and operated in accordance with various embodiments. The circuit 500 can take any number of suitable forms depending on the requirements of a given application. In some embodiments, the circuit 500 may be incorporated into a host device, such as the devices 102, 202 in FIGS. 1-2. The circuit may alternatively form a portion of a separate processing device that supplies the requisite processing described herein, such as part of a cloud-based service that operates upon all of (or a selected portion of) the RMC files associated with a particular user account. The circuit may be realized in hardware, firmware and/or software as required. In some cases, the circuit may include one or more programmable processors that utilize programming stored in a suitable memory location.

Generally, the processing circuit 500 operates upon a set of input RMC files 502 to generate a voice characteristics dynamic library (VCDL) 504 that is stored in a suitable memory location. As explained below, the VCDL provides an accumulated list of words spoken by various speakers (sources or voices) appearing in the RMC files 502, along with associated timestamps indicating the time occurrences of the associated words.

The processing circuit 500 may include a phoneme recognition circuit 506, a viseme recognition circuit 508 and a speaker identification circuit 510. Other forms of circuitry may be used, including other operative modules as required.

It is well known that complex languages can be broken down into a relatively small number of sounds (phonemes), The English Language can be classified as involving about 40 distinct phonemes. Other languages can have similar numbers of phonemes; Cantonese, for example, can be classified as having about 70 distinct phonemes. Phoneme detection systems are well known as effectively and accurately generating a text string of intelligible language from an input signal. Depending on the configuration, such systems can provide audio-to-text from an audio signal (voice recognition) and speaker-to-text from a video signal (facial recognition).

Visemes refer to the specific facial and oral positions and movements of a speaker's lips, tongue, jaw, etc. as the speaker sounds out a corresponding phoneme. Phonemes and visemes, while generally correlated, do not necessarily share a one-to-one correspondence. Several phonemes produce the same viseme (e.g., essentially look the same) when pronounced by a speaker, such as the letters “L” and “R” or “C” and “T.” Moreover, different speakers with different accents and speaking styles may produce variations in both phonemes and visemes.

The processing circuit 500 utilizes phoneme recognition and, as desired, viseme recognition processing techniques to decode audible words appearing in the RMC files 502. The phoneme recognition circuit 504 analyzes each of the RMC files 502 in turn, applying one or more phoneme recognition algorithms in conjunction with a phoneme database to identify audible words (e.g., a reference audio sequence) in an audio portion of the content files.

When employed, the viseme recognition circuit 508 can operate to apply viseme recognition to sequences of video frames in the video stream having a visible human speaker. These results can be correlated to the phoneme recognition output from circuit 506 to enhance accuracy of the audible word translation operation. The results from the circuit 508 can also be used to enhance operation of the speaker identification circuit 510.

The speaker identification circuit 510 generally operates to characterize different speakers within the audio portions of the RMC files. Unlike the viseme recognition circuit 508 which uses the video portions of the files, the speaker identification circuit 510 uses characteristics of the audio portions of the files. The circuit may employ a digital signal processing (DSP) block and database to characterize and identify the speakers.

Each new audio segment can be classified through heuristic mechanisms to identify (assign) that segment to an existing known speaker. A new speaker not matching the database may be identified as an “unknown speaker” until such time that further analysis can determine that the speaker is an existing speaker, or labeling information is entered to identify the new speaker under its own heading in the VCDL 504.

FIG. 5 further shows an exemplary format for the VCDL 504. This is merely illustrative as any number of different formats may be utilized. It will be appreciated that a given VCDL for even a modest library of RMC files could comprise dozens of speakers or more and thousands, if not millions, of individual word entries. It is contemplated that the VCDL will be a sortable, appendable data base of entries.

Generally, the VCDL is organized on a per-speaker basis. For each identified speaker, each occurrence of each word spoken by that speaker is logged as a separate entry in the table. The entry may include other information as well, such as an associated timestamp and an RMC file name. These items of information uniquely identify which RMC file the word appears, and the time occurrence for that word. Other forms of information may be logged in the table as well. For example, the characterized speaker may also form a portion of each entry. The timestamp can be expressed in any suitable form, such as elapsed time (hours, minutes, seconds, etc.) from the beginning of the RMC file, time from the end, etc. In other embodiments, the timestamp may be expressed based on a frame ID basis, such as at a particular video or audio frame sequence ID number, etc.

Some spoken words, such as “the,” may have many occurrences and therefore occupy a large number of entries in the table (or may be omitted entirely). Other more obscure spoken words may only occur once in the entire data structure. The overall size of the VCDL 504 will depend on a variety of factors including the number of speakers, the amount of intelligible audio content, the number of files described by the VCDL, etc.

While not separately shown in FIG. 5, it will be appreciated that suitable filtering, gain adjustment and other detection techniques can be applied in order to evaluate the audio content of the RMC files. For example, amateur and/or poor audio recordings with background “hiss” or other noise features can be compensated by the circuitry in FIG. 5 in order to enhance the phoneme detection processing. It will be noted that such compensation will not necessarily alter the actual playback of the RMC file, but rather, will enhance the ability of the system to detect the audio content therein. Similarly, non-spoken aspects of the audio content, such as background music, sounds, can be reduced through the use of filtering and other known signal processing techniques to enhance the ability of the system to detect the spoken portion of the audio content. It is contemplated the system will detect and classify both “human” speech and “non-human” speech (e.g., synthesized speech, etc.).

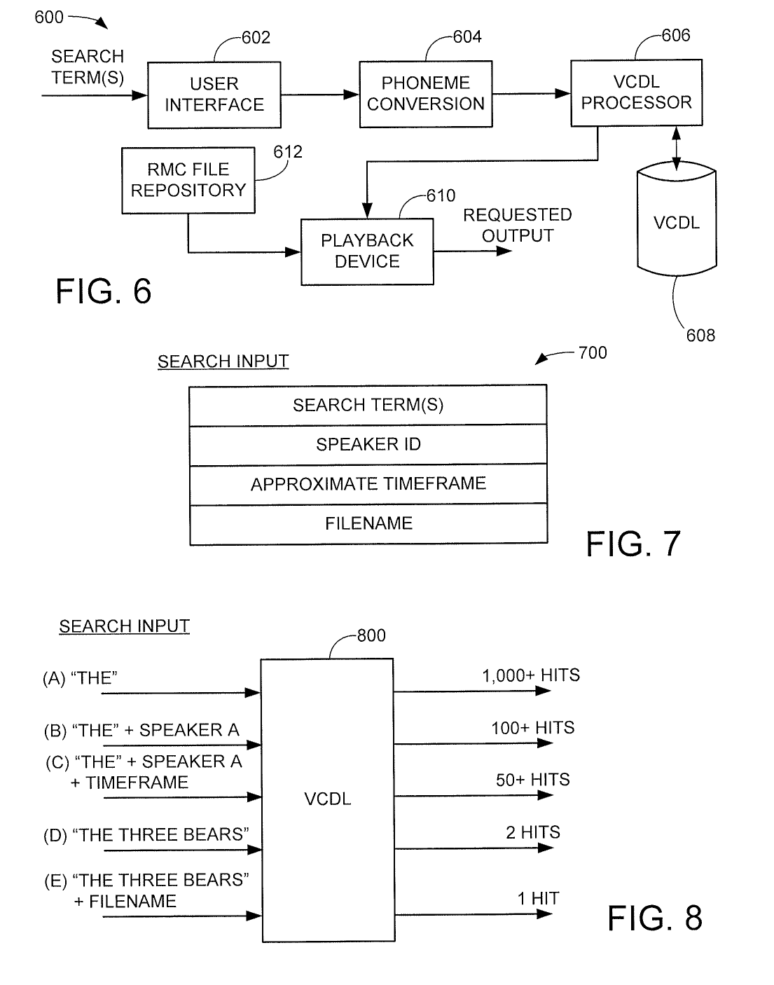

FIG. 6 illustrates a search, retrieval and playback system 600 operative to use a VCDL such as 504 from FIG. 5 to obtain requested output from a set of characterized RMC files such as 502 in FIG. 5. The system 600, hereinafter also referred to as a retrieval circuit, is merely exemplary and may take a number of different forms, including forms that involve significant user I/O inputs at different points. The retrieval circuit of FIG. 6 may be local, such as one of the client devices in FIG. 2, or may be geographically distributed so that user I/O and playback functions are carried out locally such as at a client device and search and retrieval functions are carried out remotely such as at the server level.

A user enters one or more search terms into a user interface 602. The input search terms can be provided in a variety of forms, such as typed or spoken text. Spoken text may be subjected to a phoneme conversion block 604 to convert the input search string into text.

A VDCL processing circuit 606 (such as a processor) accesses an associated VDCL 608 from memory and performs a search to match the input text search string to the contents of the VDCL. This results in the identification of a selected RMC file at the starting point at which the audio text corresponding to the input search terms commences within the file. A playback device 610 accesses an RMC file repository 612, such as a suitable memory, to initiate playback of the selected RMC file at the associated location. The various components in FIG. 6 may be local or geographically distributed. In the latter case, for example, the user interface 602 and playback device 610 maybe on a local client device, and the VCDL processing and RMC files are performed/stored remotely in a cloud computing network such as at the storage server level.

FIG. 7 illustrates a search input format to indicate different forms of search input values that can be supplied to the user interface 602. Input values can include search terms, a speaker identification (ID) value, an approximate timeframe for the requested content, and/or a selected RMC filename. Other values may be used as well. The approximate timeframe can relate to either (or both) the datecode of production associated with the RMC file, such as a range of dates in which the content was believed to have been generated, or an elapsed time within the RMC file, such as a range of time (e.g., first half of the RMC file; about eight minutes into the file, etc.).

FIG. 8 shows another exemplary VCDL data structure 800 to illustrate different search strategies based on different search input values. The different search strategies are labeled from (A) to (E). The first search (A) involves a simple search for all occurrences of the word “the” in the VCDL. As can be seen, this results in a first, large number of matches (1000+ hits). This result is based on the fact that the word “the” is commonly employed and all hits by all speakers would be grouped in the output search results.

Search (B) uses the term “the” plus the identification of a particular speaker (“Speaker A”). This narrows the number of matches (100+ hits), and represents all of the occurrences of the word “the” as spoken by the selected Speaker A. Search (C) adds a selected time frame to the strategy for Search (B). Depending on the range of the time frame, this may result in a narrowed search set (50+ hits).

Search (D) uses a longer search term, “the three bears.” Adding additional terms to the search string significantly narrows the search set (2 hits in this example). It will be appreciated that the search can be for the specific string, or can be tailored for hits involving all three of these words in any order within a given elapsed time interval. Finally, Search (E) adds a file name to Search (D). This narrows the search further to a single output (1 hit). It will be appreciated that the simplified illustration from FIG. 8 is merely for purposes of providing a concrete example. The actual number of results for any given search string will vary widely depending on the population of the VCDL, etc.

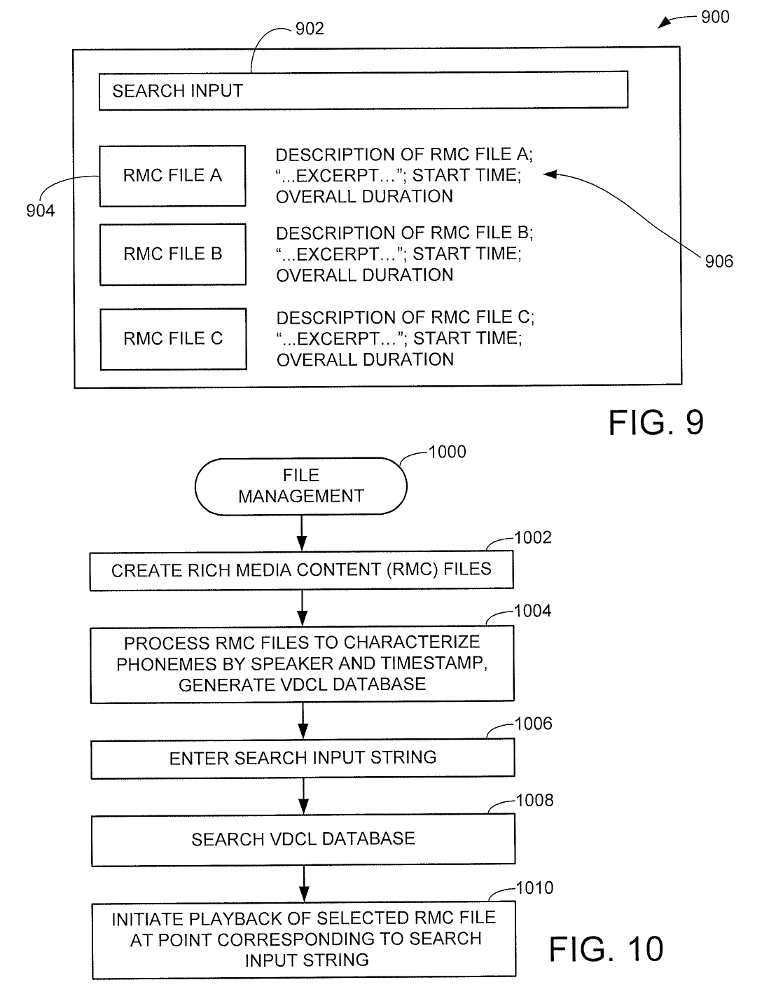

FIG. 9 is a representation of a user interface 900 that can be utilized for VCDL search inquires as discussed in FIGS. 6-8 in accordance with some embodiments. The user interface 900 may take the form of an interactive menu on a display device, such as a computer screen. User inputs can be provided from suitable devices (e.g., keyboard, mouse, touch screen, etc.) to interact with the system. Other formats, including advanced search options, can be provided.

A search input may be entered via field 902. The search input is supplied to the VCDL processing circuit 606 (FIG. 6) and multiple corresponding hits are displayed at 904 and 906. In the embodiment represented in FIG. 9, the field 904 may indicate the associated RMC file (e.g., files A, B, C, etc.), and may include an icon to denote the particular type of file (such as a movie, etc.). The field 906 may provide a brief description of the associated file along with other information such as an excerpt including the search input, the start time of the location of the excerpt, a duration of the entire file, etc.

It is contemplated in some embodiments that the search results in FIG. 9 may be returned in the form of a search engine or other well known media search format. The user may select (e.g., click on using a mouse) the desired file, and the playback device 610 will initiate playback of the file in the vicinity of the requested input. The playback may be provided on the same screen that displayed the user interface 900.

In some cases, the playback will initiate within a selected time frame of the detected text, such as five (5) seconds prior to the detected occurrence. This time frame may be adjusted through user selection (e.g., from one (1) second to 30 seconds prior to the occurrence, etc.). In other cases, a repeating loop option can be generated whereby a selected clip of selected duration, such as 15 seconds, may be repeated until the user ceases further playback.

A user may manually select files to be incorporated into the VCDL data structure. Files can be easily added or deleted through a suitable user interface. In some cases, all RMC files uploaded to a particular user account, such as a cloud network account, can be automatically added to a VCDL data structure for that account. Access rights can be restricted to users having authorization to the files. In other embodiments, a large number of publicly available RMC files can be processed into a main VCDL data structure for access by multiple users. A commercial video hosting service, for example, may choose to index the content files of different categories into separate VCDL data structures. In this way, the system can facilitate searches for particular audio strings, display the associated files having the input string, and queue up and begin playing the files at the appropriate time so that the desired audio is displayed. While spoken words have been exemplified, the above processing can readily be applied to other forms of audio, including music lyrics.

Further user interface options can include enabling the user to identify the individual speakers in the various RMC files by name or other identifiers. Video frames from the video portions of the RMC files can be displayed, for example, that show the face of the associated speakers. This can be provided, for example, by the viseme recognition block. The video frames with the speakers' faces can be displayed to the user to signify the different speakers. The user can input names for these speakers as desired, and this information can be incorporated into the VCDL. In sophisticated systems, automated detection of speaker names can be implemented and assigned using leading audio indicators in the audio signal, which can be confirmed or corrected by the user.

FIG. 10 provides a file management routine 1000 to summarize the foregoing discussion in accordance with some embodiments. One or more rich media content (RMC) files are created at step 1002. As mentioned above, the RMC files may take any number of suitable forms and at least include an audio portion involving human speech. The RMC files are stored in one or more memory locations, including locally or across a network, accessible by a processing circuit as set forth in FIG. 5.

The RMC files are processed at step 1004 to characterize various phonemes appearing within the audio portion of the files. The phonemes are converted to text and stored in a voice characterization data library (VCDL) structure. Additional information is stored in the VCDL as well, such as timestamp and file name information. The VCDL is stored in a suitable memory location, including locally or across a network, accessible by a VCDL processing circuit as set forth in FIG. 6.

A suitable user interface is used at step 1006 to enter a search input string. The user interface may take the form as set forth in FIG. 9, or may take some other form. The VCDL processing circuit locates and displays one or more hits for the user based on the search input string at step 1008. The user selects a desired RMC file and the system initiates playback at an intermediate point in the RMC file in the vicinity of, and just prior to, the occurrence of the search input string in the selected file.

In this way, playback of the RMC file on a display device is initiated beginning at the intermediate point of the RMC file responsive to the time stamp associated with the selected spoken word, and that portion of the RMC file prior to the intermediate point is not displayed to the user. This eliminates the need for a manual search operation to locate the intermediate point, since the system uses the timestamp data to calculate an appropriate starting point to begin playback.

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A computer-implemented method comprising:
using a processing circuit to identify a reference audio sequence in an audio portion of a media content file;
storing a data structure in a memory that links each portion of the reference audio sequence with an associated time stamp that identifies a time location of the associated portion of the reference audio sequence within the media content file with respect to a reference point of the media content file;
searching the data structure using an input search string to identify a selected portion of the reference audio sequence in the media content file; and
initiating playback of the media content file on a display device beginning at an intermediate point of the media content file corresponding to the time stamp associated with the selected portion of the reference audio sequence.

2. The method of claim 1, wherein the data structure comprises a plurality of entries, each entry comprising a different one of a plurality of spoken words identified by the processing circuit and the associated time stamp in the reference audio sequence in the audio portion of the media content file.

3. The method of claim 2, wherein each entry further comprises a file name for the associated media content file of the plurality of media content files in which the associated spoken word for that entry occurs.

4. The method of claim 2, wherein each entry further comprises a speaker identification (ID) value that identifies a particular human speaker that spoke the selected spoken word.

5. The method of claim 1, further comprising using a user interface on a client computing device to enter the input search string and to display the media content file beginning at the intermediate point.

6. The method of claim 1, further comprising calculating the intermediate point in relation to the time stamp and a buffer value, the playback of the media content file initiated at the intermediate point without a prior display of any portion of the media content file prior to the intermediate point.

7. The method of claim 1, wherein the processing circuit comprises a phoneme recognition circuit and the spoken words are identified responsive to an application of a phoneme recognition algorithm to an audio portion of the media content file.

8. The method of claim 7, wherein the processing circuit further comprises a viseme recognition circuit and the spoken words are further identified responsive to an application of a viseme recognition algorithm to detected human faces in a video portion of the media content file.

9. The method of claim 1, wherein the processing circuit further comprises a speaker identification circuit which applies digital signal processing (DSP) analysis to an audio portion of the media content file to identify different first and second human speakers, so that a first portion of the spoken words are identified in the data base as having been spoken by the first human speaker and a second portion of the spoken words are identified in the data base as having been spoken by the second human speaker.

10. The method of claim 1, wherein the processing circuit is located in a network/cloud data storage system and the media content file is stored on one or more of a plurality of data storage devices of the network/cloud data storage system.

11. The method of claim 1, wherein the input search string is provided by the user as spoken text, and the method further comprises applying phoneme recognition to the spoken text to convert the spoken text to typed text.

12. The method of claim 1, further comprising updating the data structure with associated spoken words and time stamp values for a plurality of additional media content files.

13. An apparatus comprising:
a processing circuit configured to identify a sequence of spoken words in an audio portion of a rich media content (RMC) file stored in a first memory, the processing circuit further configured to generate, and store in a second memory, a data structure that links each of the spoken words with an associated time stamp that identifies a time location of the spoken word within the RMC file with respect to a beginning of the RMC file; and
a retrieval circuit configured to search the data structure using an input search string to identify a selected spoken word in the RMC file, and to queue the RMC file in a configuration to facilitate access to the RMC file at the associated time location by a requesting computer.

14. The apparatus of claim 13, wherein the processing circuit comprises a phoneme recognition circuit which applies a phoneme recognition algorithm to the audio portion of the RMC file to detect each of the spoken words.

15. The apparatus of claim 13, wherein the processing circuit comprises a speaker identification circuit which applies digital signal processing (DSP) analysis to the audio portion of the RMC file to identify different first and second human speakers, so that a first portion of the spoken words are identified in the data base as having been spoken by the first human speaker and a second portion of the spoken words are identified in the data base as having been spoken by the second human speaker.

16. The apparatus of claim 13, wherein the processing circuit comprises a viseme recognition circuit which applies a viseme recognition algorithm to detected human faces in a video portion of the RMC file to detect the spoken words in the audio portion of the RMC file.

17. The apparatus of claim 13, wherein the retrieval circuit comprises a user interface on a client computing device configured to facilitate entry of the input search string by a user and to display the RMC file beginning at the intermediate point to the user, wherein the processing circuit forms a portion of a remote server in a cloud computing data storage system, and the RMC file is stored in at least one data storage device of the cloud computing data storage system.

18. The apparatus of claim 13, wherein the retrieval circuit is further configured to calculate the intermediate point in relation to the time stamp and a buffer value, and to initiate the playback of the RMC file at the intermediate point without a prior display of any portion of the RMC file prior to the intermediate point.

19. An apparatus comprising:
a first programmable processor having associated programming in a memory location which, when executed, uses phoneme recognition to identify a sequence of spoken words in each of a plurality of rich media content (RMC) files stored in a memory, generates a data structure that links each of the spoken words with an associated time stamp that identifies a time location of the spoken word within the associated RMC file and an associated human speaker which spoke the associated spoken word, and stores the data structure in a memory; and
a second programmable processor having associated programming in a memory location which, when executed, is configured to search the data structure using an input search string to identify a selected spoken word in the RMC file, and is configured to initiate playback of the RMC file on a display device beginning at an intermediate point of the RMC file responsive to the time stamp associated with the selected spoken word.

20. The apparatus of claim 19, further comprising a third programmable processor having associated programming in a memory location which, when executed, generates a user input on the display device to facilitate entry of the input search string by a user, wherein during subsequent playback of the RMC file on the display device beginning at the intermediate point, no portion of the RMC file prior to the intermediate point is displayed to the user.
